(19) United States
(12) Patent Application Publication
(10) Pub. No.: US 2003/0235480 A1
(43) Pub. Date: Dec. 25, 2003

(54) Product protector for center beam flat cars

(76) Inventors: Stuart H. Thomson, Downers Grove, IL (US); Robert S. Trent, Berwyn, IL (US)

Correspondence Address: David C. Brezina, Barnes & Thornburg, P.O. Box 2786, Chicago, IL, 60690-2786, US

(21) Appl. No.: 10/413,334

(22) Filed: Apr. 14, 2003

Related U.S. Application Data
(63) Continuation-in-part of application No. 09/689,436, filed on Oct. 12, 2000, now abandoned.
(60) Provisional application No. 60/158,886, filed on Oct. 12, 1999.

(51) Int. Cl. B60P 1/64

(52) U.S. Cl. 410/87

(57) ABSTRACT

A product protection pad utilizes a lubricating plastic that moves across the face of an upright post of a center beam flat car in order to reduce or eliminate damage to product or product wrappers and in one a first embodiment uses a self centering flanged aperture to permit the movement as the car flexes, twists or wracks and in an alternative embodiment utilizes a strong, lubricating plastic, both embodiments being mounted to the car using recessed weldable washers. In a third embodiment the pad is in the form of a cap that wraps about the post. The cap provides a cargo engaging face, a post grasping section along one side edge and a securement leg which extends rewardly of the cargo face and is securable to the post by a welding side of the structure and a retaining structure to a side of the post.

### CLAIM OF PRIORITY

This application is a continuation-in-part and claims priority based on provisional patent application Serial No. 60/158,886 filed Oct. 12, 1999, entitled “PRODUCT PROTECTOR FOR CENTER BEAM FLAT CARS”, non-provisional application Ser. No. 09/689,436 filed on Oct. 12, 2000, and the related continuing prosecution and co-pending application filed Dec. 13, 2002.

### BACKGROUND OF THE INVENTION

1. Field of the Invention

The invention relates to wear reducing pads particularly adapted to mounting on vertical structural members on movable vehicles such as railcars, semitrailers, or other structures having a main longitudinal center beam of a deep section against which cargo is in contact. In particular it is adapted for use on center beam flat cars.

2. Description of Related Art

A variety of lading protector items have been used on center beam rail flat cars. These can include a wide variety of temporary materials. Typically, a resilient material such as a plastic foam is taped or strapped to the vertical posts that comprise a portion of the center beam. These protect the load from contacting the hard, rough surface of the vertical post of the center beam, and resists the resulting damage to the surface, edges, or wrapping of the cargo. This may be used, for example, to protect loads such as lumber or wrapped wall board, or similar materials.

This solution is a temporary solution that inevitability results in a destruction of the foam and does not necessarily resist all damage to the surface of the cargo. Similarly, other types of fixed pads, bumpers, or even lumber secured vertically share the problems of dealing with the inevitable movement as the railcar is pulled in a train. Due to the heavy loads carried and the large moment of forces applied, even very strong railcars are subject to a variety of flexing, wracking, and other forces that result in relative motion between the railcar and the cargo.

Study of the form of damage to the cargo wrap surface has yielded the descriptive term “sticktation” to refer to the phenomenon of generally low friction materials (such as the cargo wrapping and the steel of the car) under high load and repetitive, but subtle motion, and considering the distortion of the materials themselves under load. “Sticktation” combines a coefficient of friction and material distortion under actual conditions increasing to the point where one or both of the materials suffers damage. The alternatives of the invention eliminate the adverse effects of “sticktation.”

### SUMMARY OF THE INVENTION

This invention provides a product protection pad that utilizes a lubricating plastic that moves across the face of an upright post of a center beam flat car in order to reduce or eliminate damage to product or product wrappers and in one a first embodiment uses a self centering flanged aperture to permit the movement as the car flexes, twists or wracks and in an alternative embodiment utilizes a strong, lubricating plastic, both embodiments being mounted to the car using recessed weldable washers.

The invention also relates to a cap or sleeve-like construction that fits about and is secured to center beam vertical posts. The cap includes a front face or forward cargo engaging surface and is secured along its side to the post so as to assure that the cargo engages only the cargo engaging surfaces and not securement devices. The securement is by welding and/or retainer tab.

### BRIEF DESCRIPTION OF THE DRAWINGS

FIG. 1 is a front elevational view of a product protector pad;

FIG. 2 is a sectional view of a product protector pad;

FIG. 3 is an elevational view of an embodiment of the product protector for center beam flat cars with an array of staggered floating product protector pads;

FIG. 4 is an elevational view of an embodiment of the product protector for center beam flat cars with an array of paired floating product protector pads;

FIG. 5 is an enlarged sectional view of the washer and pad of one embodiment;

FIG. 6 is a plan view of the pad of the invention;

FIG. 7 is an enlarged sectional view of the side edge of the pad of one embodiment;

FIG. 8 is a plan view of the pad of a second embodiment of the invention;

FIG. 9 is an enlarged sectional view the pad of a second embodiment of the invention;

FIG. 10 is a perspective view of a portion of a center beam flat car showing cargo, the center beam and the posts;

FIG. 11 is an enlarged and perspective view of the protective cap mounted to an angle iron style post;

FIG. 12 is a sectional style view taken along line 12-12 of FIG. 11 showing the cap secured to the post;

FIG. 13 shows two posts in a Z style and in cross section.

FIG. 14 shows in cross section, an H or I-like beam construction with a pair of protective caps mounted thereon;

FIG. 15 shows, in perspective, the retainer system for mounting a cap to the beam of FIG. 14.

FIG. 16 shows, in cross section, a Z-like beam construction with a pair of protective caps mounted therein;

FIG. 17 shows, in perspective, the retainer system for mounting a cap to the beam of FIG. 16; and

FIG. 18 shows, in cross section or channel shaped beam construction with a pair of protective caps mounted thereon.

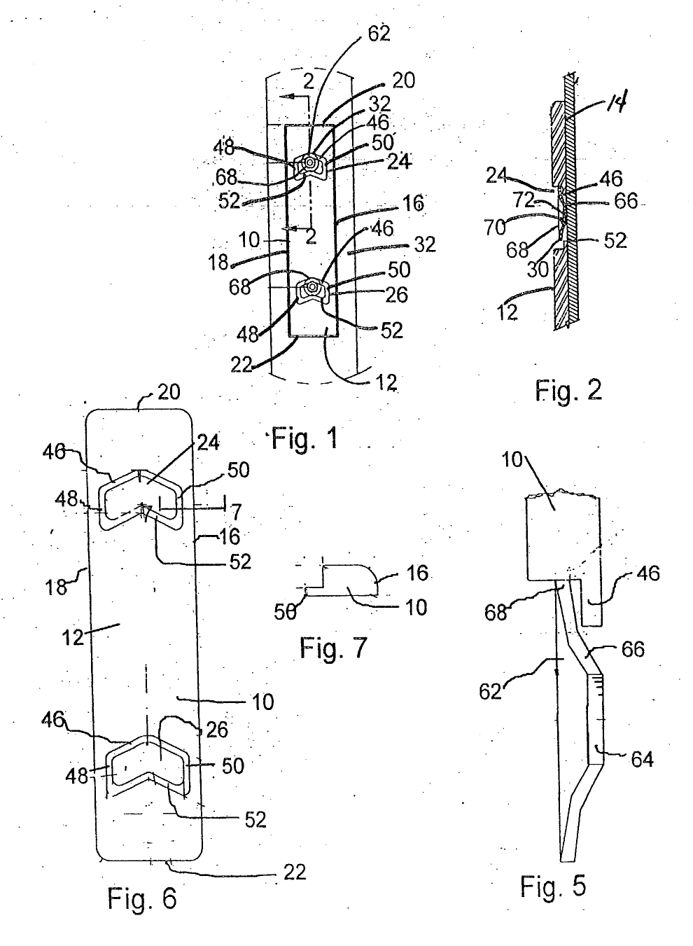

### DETAILED DESCRIPTION OF THE INVENTION

A product protector pad 10 is formed from a piece of self lubricating plastic such as UHMW-PE, HMW, reground UHMW or other such self lubricating plastic. The shape of the pad 10 includes one embodiment which is flat, defined by a cargo contact surface 12, a flat car contact surface 14 with side edges 16, 18 and end edges 20, 22 so as to be about ¼″ to ½″ thick, and is approximately 4″ wide and 16″ long. Thicker pads may also be used depending on the primary use of the intended center beam flat car and economic and environmental considerations.

The pad 10 in this first embodiment is formed so as to have two inverted “V” grooved apertures 24, 26 that allow fastening using fastening arrangement 30 aligning the pad vertically to the upright members 32 of a center beam flat car 34. These can be placed on both sides 36, 38 of the car 34 and selectively spaced in upper and lower positions 40, 42 in one of two preferred alignment schemes, the staggered alignment scheme of FIG. 3 or the vertically paired two position alignment scheme of FIG. 4. The staggered alignment scheme alternates between the upper and lower positions 36, 38 on adjacent uprights 32, while the paired two position alignment uses pads 10 in both the upper and lower positions 36, 38 on each upright 32.

The design of the first embodiment is such that the pad can “float” from side to side about ⅞″ or more as the center beam car “wracks” or twists in motion. The solid plastic material provides durability and ease of movement, while greatly minimizing labor needed in loading the car as special temporary pads need not be used. The movement prevents friction between the cargo and car so that the typical cargoes, such as lumber or wallboard, wrapped or unwrapped are not damaged by their edges or wrappers contacting the car uprights 32.

In the alternative embodiment, which, at the time of filing of this application, is being tested and may well be preferred, is also flat, having a cargo contact surface 112, a flat car contact surface 114 with side edges 116, 118 and end edges 120, 122 so as to also be about ¼″ to ½″ thick, and approximately 4″ to preferably 5.5″ wide and 16″ long. As with the first embodiment, thicker pads may also be used depending on the primary use of the intended center beam flat car and economic and environmental considerations.

In the alternative embodiment, the pad 110 is formed so as to have a pair of generally circular apertures 124, 126 that allow fastening using fastening arrangement 30 mounting the pad in a selected vertical and horizontal to the upright members 32 of a center beam flat car 34. It will be understood by one of ordinary skill will adapt either the first or second embodiments to be placed on both sides 36, 38 of the car 34 and selectively spaced in upper and lower positions 40, 42 in the staggered alignment scheme of FIG. 3 or the vertically paired two position alignment scheme of FIG. 4.

The design of the first embodiment is such that the pad can “float” from side to side about ⅞″ or more as the center beam car “wracks” or twists in motion. The solid plastic material provides durability and ease of movement, while greatly minimizing labor needed in loading the car as special temporary pads need not be used. The movement prevents friction between the cargo and car so that the typical cargoes, such as lumber or wallboard, wrapped or unwrapped are not damaged by their edges or wrappers contacting the car uprights 32.

The invention in both the first and second embodiments utilizes a lubricating plastic. The first embodiment moves across the face of an upright post of a center beam flat car. This movement is intended to reduce or eliminate tearing of product wrappers. Lubricating plastic minimizes resistance to movement formed by both friction and that adhesion derived from material contact between the plastic pad 10 and steel upright 32.

In the first embodiment, grooved apertures 24, 26 are formed and arranged to have flanges surrounding the internal edge, forming an upper flange 46, side flanges 48, 50 and a lower flange 52. Shaping the flanged apertures 24, 26 as inverted “V's” it allows this floating piece to return to a “neutral” or centered location by gravity when the car is empty, as the mass of the pad 10 is borne by outer flange 68 as shown in FIG. 5. The car 34 will then be easily ready for the next load without, or with minimal, adjustment or resetting of pads 10. Side flanges 48, 50 and lower flange 52 provide retention of the pad during car operation. Limit on movement is provided by the outer flanges 68.

In both embodiments, fastening arrangement 30 preferably uses a washer 62. Washer 62 is formed in a dished shape in the manner of, or using actual production shapes for washers known as “weld washers.” These are originally designed to be fixedly welded to metal structural members for permanent affixation of non-weldable members to the metal structure. However, this arrangement mounts pads 10 differently than the typical use of weld washers.

It can be seen that washer 62 is formed to have aperture 64 surrounded by an inner recessed flange 66 and having at its perimeter an outer flange 68. Between the flanges is a stepped web 70 which spaces the outer flange from the inner flange 66. The material of the inner flange 66 is welded with a bead 72 to upright 32 in the selected upper or lower position 40, 42. In the first embodiment, the spacing of washer flanges 66, 68 due to the displacement of web 70 is greater than the thickness of pad flanges 46, 48, 50, 52 which thereby permits the movement of pad 10 as the car 34 flexes, twists and wracks. In the first embodiment, the weld washer is used to hold the plastic product protector pad 10 on the rail car 34 without a tight fit. It merely helps to guide it during its travel of ⅞″ or more.

In the alternative embodiment, which, at the time of filing of this application, is being tested and may well be preferred, apertures 124, 126 are formed and arranged to have continuous flanges surrounding the internal edge, forming an upper flange portion 146, side flange portions 148, 150 and a lower flange portion 152. Shaping the flanged apertures 124, 126 in this manner fixes the pad 110 on the car limiting movement with the outer flanges 168.

When compared to the prior art such as use of plastic foam, it has been discovered that in the fixed embodiment an oil filled plastic formed having a sufficient bearing surface but also having rounded edges can adequately limit “sticktation” yet is highly wear resistant and durable, and also possesses sufficient mechanical strength for the mounting arrangement taught herein. A material such as TIVAR® oil filled plastic sold by Poli Hi Solidor of Fort Wayne, Ind., uses oil to enhance the self lubricating properties as compared to non-oil filled self lubricating plastic such as UHMW-PE, HMW, reground UHMW of other such self lubricating plastic.

Specific properties of a desirable self lubricating plastic, particularly for the fixed embodiment:

| Property | Value | Unit |
|---|---|---|
| Density | 927-938 | kg/rn3 |
| Yield Point | 7.8-18.4 | MPa |
| Elongation at Yield | 12-18 | % |
| Tensile Break | 50 | MPa |
| Elongation at Break | 280 | % |
| Tensile Modulus | 524 | MPa |
| Flexural Modulus | 440 | MPa |
| Izod Impact | 76 | kJ/m² |
| Tensile Impact | 2868 | kJ/m² |
| Sand Wheel Wear | 110t-1000 = 100 | |
| Hardness | 65 | Shore D |
| Static Friction | 0.208 | |
| Dynamic Friction | 0.195 | |
| Thermal Expansion | 0.00018 | Degrees C. |
| Melt Point | 137-143 | Degrees C. |
| Compressive Modulus | 290 | MPa |
| Compressive Deformation | | % |
| Volume Resistivity | >10\hat{ }15 | Ohm-cm |
| Surface Resistivity | >10\hat{ }15 | Ohm |
| Water Absorption | | nil % |

In addition to the design feature incorporating the oil-filled plastic, the use of rounded surfaces combines with the low friction of the plastic to prevent sticktation of the lumber wrap. As described above, “sticktation” is a result of a complex combination of material and load properties, coupled with complex forces imposed by rail travel. The use of a soft material, as in the prior art, does not adequately negate all the complex factors which cause damage. Contrary to conventional considerations, a stiffer, stronger material, albeit with a smooth, self lubricating surface, and having strongly rounded edges, provides superior performance.

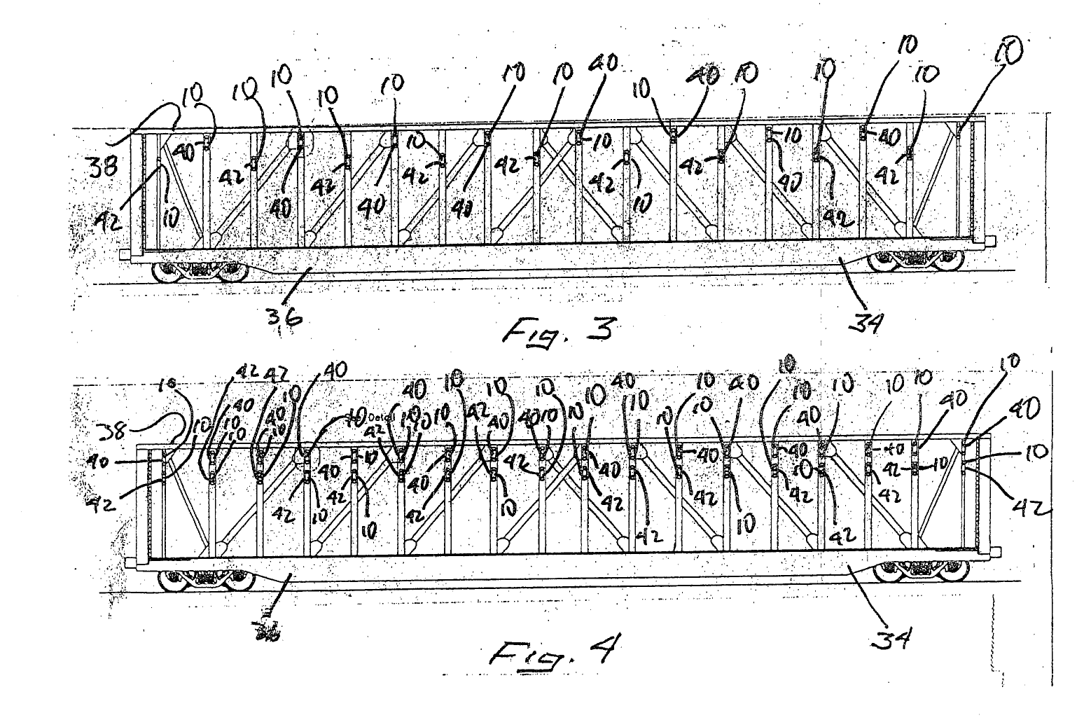

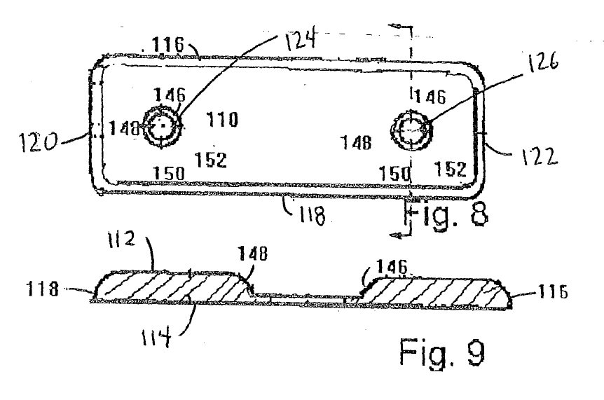

It will be seen in FIG. 8 and FIG. 9 that edge 116 has the radius carried from the contact surface 112 through to the flat car contact surface 114, while, as shown in FIG. 7, the radius on edge 16 has a smaller relative diameter, merging into a flat portion normal to car contact surface 14. Additionally, it will be seen that fastener mounting recess radius 180 is also carried substantially continuously curved from surface 112 to flange portions 146, 148, 150, 152. An additional variation in the fixed embodiment as compared to the first embodiment is to make the washer deeper, so as to enable a deeper, hence stronger, flange. The teachings above regarding the washer will enable this modification given the other disclosures herein.

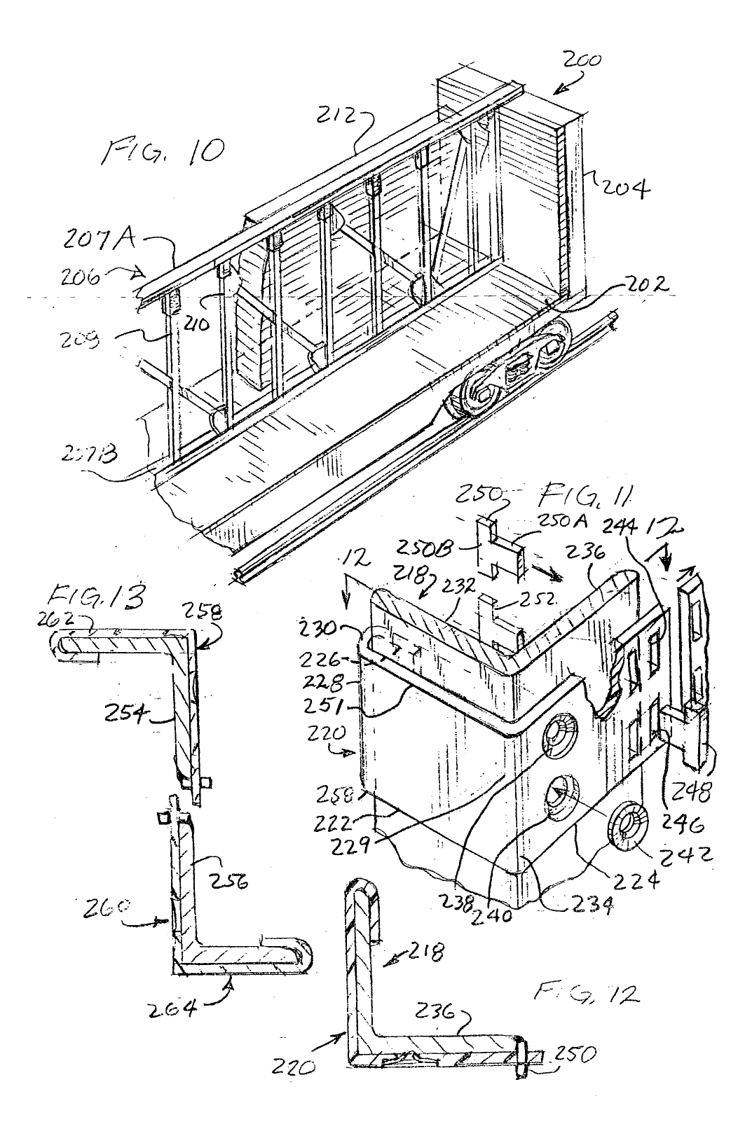

Turning now to FIG. 10, a center beam flat car 200 is shown which includes a flat floor 202, end walls such as 204 and a fabricated center beam web assembly 206. The web assembly 206 includes a top and a bottom flange 207A, 207B and a plurality of vertical center posts such as 208 and 210 that extend between the flanges. For purposes of illustration, lading or cargo, 212 as shown on one side at one end of the car. The lading is shown as stacked sheets such as plywood that contacts the center post. It is to be understood that in real shipment (as opposed to illustration) the load is balanced and evenly distributed. Referring now to FIG. 11, each vertical post such as 208 or 210 is an angle iron element such as 218.

It will be appreciated that the post can be formed of many different configurations with different cross-sections such as those that have a H or Z shape.

The cap 220 generally is made of the plastic, as described herein before, and is shaped to fit the angle iron members 218. The cap 220 includes a cargo-engaging face or leg 222. A securement leg 224 is provided at one side of the cargo-engaging face 222. A short return or web-grasping leg 226 is provided along the other side edge and extends behind the cargo-engaging face 222 toward the securement leg 224 that is provided on the other side edge.

It will be understood that the cap 220 can be a one-piece formed member or a multiple-piece fabricated member.

The return leg 226 is connected to one side edge 228 of the cargo face 222 by a bight portion 230. The leg 226 extends toward the securement leg 224 and is spaced from the cargo face 222. The spacing between the leg 226 and face 222 is suitable to grasp the angle iron leg, such as 232, of the angle iron post 218.

If the space defined by the leg 226 and face 222 is greater than the thickness of the web to be grasped, a shim or shims can be used to assure a grasping of the web. The securement leg 224 is connected to the other side edge 234 of the face 222 and opposite edge 229. The securement leg is shown extending at right angles to and rearwardly of the face 222 for positioning against angle-iron leg 236. The securement leg 224 defines two (2) weld washer receiving apertures 238 and 240 each of which define a tapered surface extending from back to front with the aperture being smaller at the back or inner surface adjacent the angle iron leg 236 and larger at the front or outer surface. A pair of weld washers such as washer 242, each of which is tapered like a Bellville washer, fit an aperture like 238 or 240, and are welded to the angle iron leg 236 to secure the cap 220 to the angle iron 218.

In addition, there is provided a tab-like retainer system for cooperation in securing the cap 220 to the angle-iron 218. The system includes a plurality of elongated slots such as 244 and 246 which are defined by the securement leg 224 and positioned rearwardly of the weld apertures such as 238 and 240, with the weld aperture between, the cargo face 222 and the tab-slots 244 and 246. T-shaped retainers such as 248 and 250 having a long leg such as 250A and a cross member 250B which define retaining shoulders are provided. The retainer leg such as 250A is sized to be received by the slot such as 244 and when so received the cross member 250B and thus retaining shoulders can engage the securement leg 224. The retainer leg 250A fits through the slot 246 and can be welded to the angle iron so as to further secure the cap 220 to the angle iron 218.

The length of the securement leg 224 can be adjusted to length of the angle iron 236 by cutting off excess length while still assuring use of the weld washers such as 242 and tab-retainer system.

Referring now to the cargo engaging face 222 it is seen that the vertical side edges 228 and 229 are rounded. The top and bottom edges 251 and 258 respectively are also rounded or beveled. Use of this rounding or beveling of the edges minimizes snagging of the cargo on the cap. The desirable plastic material per se is UHMW-PE with a dry-slide additive. Specific properties of a desirable self lubricating plastic are set forth herein before.

FIG. 12, shows the post 218 and cap 220 in section and particularly the retainer such as 250 welded to the iron leg 236.

A Z-shaped post system fabricated from two (2) angle irons 254 and 256, each fitted with a cap 258 and 260, is shown in FIG. 13. Each cap has a cargo engaging face 262 and 264 whereby cargo on either side of the center beam, can engage a cap. Otherwise, the cap is as previously described.

Other alternative cap and post constructions are shown in FIGS. 14-18.

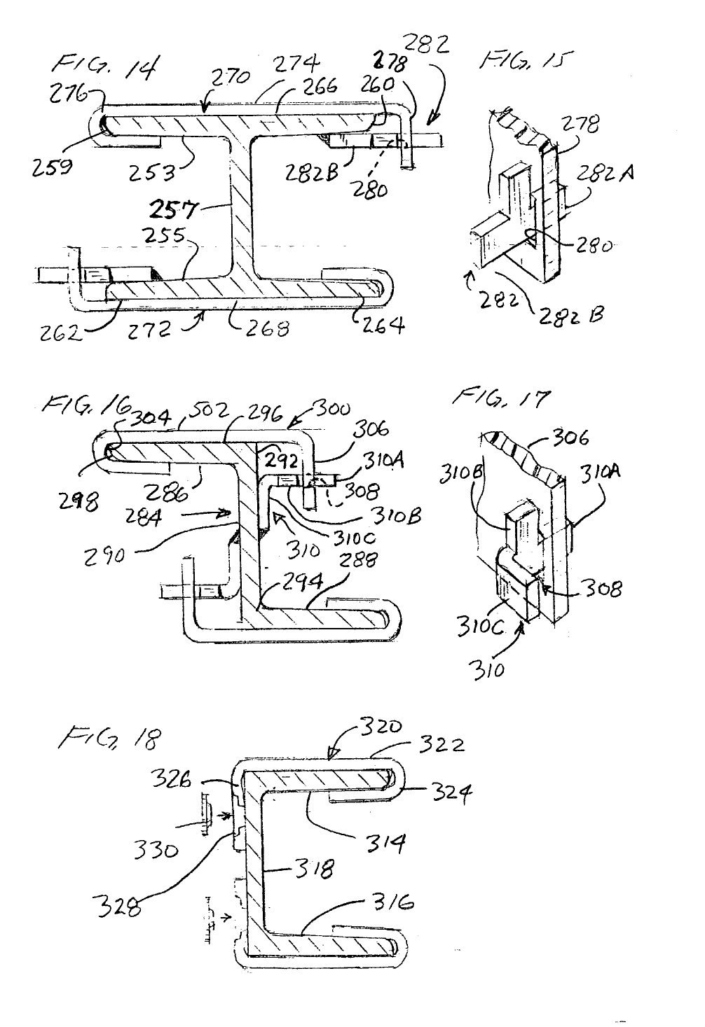

Referring now to FIGS. 14 and 15, an I beam is 251 is shown and has an upper flange 253, a lower flange 255 and a web 257 that connects to the central portion of each flange. Each flange also includes outer edges such as 259, 260, 262, and 264. The flanges also define cargo retaining surfaces 266 and 268. A pair of substantially identical protective caps 270 and 272 are mounted to each of the flanges 253 and 255. A cap such as 270 includes a cargo engaging face 274 that is positioned against surface 266. The grasping section 276 extends from one side edge of the face 274 around edge 259 and grasps the back of flange 253 like a clip. A securement leg 278 is connected to the other side edge of the face, extends rearwardly and about edge 260. A slot 280 in the leg cooperates with a T shaped retainer 282 member to receive a leg 282A of the retainer. Another leg 280B extends toward the web 257 from the leg 278. The leg 280B is welded to the back side of flange 266. With this construction, the cap 270 is fitted to the post 251 and positioned to engage cargo resting against the cap. It will be appreciated that the other cap 272 is of substantially the same construction as cap 270.

Turning to FIGS. 16 and 17 a Z shaped beam 284 is shown. The beam includes upper and lower flanges 286 and 288 and a web 290 that connects to edges 292 and 294 of each flange. Each flange defines a cargo engaging face such as 296 and an outer free edge such as 298. A protective cap 300 is mounted to the beam. A cargo engaging face 302 is positioned adjacent the flange 296. A grasping section 304 (like section 276) fits about edge 298 and clips to the back of flange 286. A securement leg 306 (like leg 278) extends from the other edge of the face 302. The leg includes a retainer slot 308. A T-shaped retainer 310 fits within the slot and is welded to the web 290. The retainer includes a first leg 310A that fits in slot 308, a second leg 310B at right angles to the first leg 310A and which engages the leg 306 and a third leg 310C which is also at right angles to leg 310B and is bent as to engage and be welded to web 290. Using the grasping section 304 and securement leg 306 and retainer system 308 and 310 the cap 300 is positioned on the post and the cargo engages face 302 is positioned to engage and minimize damage to cargo on the car.

A C or channel shaped beam 312 is seen in FIG. 18. The channel includes upper and lower flanges 314 and 316 which are joined by a web 318. Protective caps, such as 320 (which is similar to a cap such as 300) are mounted to the beam so that the cargo engaging face such as 322 is positioned against the flange such as 314. The grasping section such as 324 extends about the free edge of the flange and in effect clips to the flange. The securement leg 326 is on the other side of the face 322 and is positioned against the web 318. The leg includes at least one tapered aperture 328 which receives a tapered weld washer 330. The weld washer 330 is welded to the web 318 and thus secures the cap in place on the C shaped or channel shaped beam 312.

It will be appreciated that numerous changes and modifications can be made to the embodiment disclosed herein without departing from the spirit and scope of this invention.

We claim:

1. A product pad comprising:
a self-lubricating plastic material having a combination of low friction and relatively high strength, stiffness and resistance to compression;
said pad being formed for mounting on the face of an upright member of a cargo carrying vehicle in order to reduce or eliminate damage to product or product wrappers;
a flanged aperture to receive a weldable washer for retention of said pad on the post.

2. The pad of claim 1 and:
said aperture being formed in an inverted “V” shape such that movement of said paid is permitted as the moves by flexing, twisting or wracking.

3. The pad of claim 1 and:
said aperture being formed in a generally circular shape such that said flanges retain said pad in position as located by said weldable washer.

4. The pad of claim 1 and:
said washer being formed with a central portion for contacting and welding to said upright member;
said central portion merging into a raised flanged portion adapted to capture said pad flange against said upright member.

5. The pad of claim 1 and:
said pad being formed so as to have a density of about 927-938 kg/m³, a Yield Point of at least about 17.8-18.4 Mpa, an elongation at yield of about 12-18%, a tensile break of at least about 50 Mpa, an Elongation at Break of at least about 280%, a Tensile Modulus of at least about 524 Mpa, a Flexural Modulus of at least about 440 Mpa, an Izod Impact of at least about 76 kJ/m², a Tensile Impact of at least about 2868 kJ/m², a Sand Wheel Wear of about 110 t-1000=100 or greater wear resistance, a Hardness of at least about 65 Shore D, a Static Friction of about 0.208 or lower friction, a Dynamic Friction of about 0.195 or lower friction, a Thermal Expansion of about 0.00018 Degrees C., a Melt Point of about 137-143 Degrees C., a Compressive Modulus of at least about 290 Mpa, a Compressive Deformation of at least about 454%, a Volume Resistivity of greater than about 10¹⁵ Ohm, a Surface Resistivity of greater than about 10¹⁵ Ohm, and a negligible Water Absorption.

6. The pad of claim 3 and:
said pad being formed so as to have a density of about 927-938 kg/m³, a Yield Point of at least about 17.8-18.4 Mpa, an elongation at yield of about 12-18%, a tensile break of at least about 50 Mpa, an Elgongation at Break of at least about 280%, a Tensile Modulus of at least about 524 Mpa, a Flexural Modulus of at least about 440 Mpa, an Izod Impact of at least about 76 kJ/m², a Tensile Impact of at least about 2868 kJ/m², a Sand Wheel Wear of about 110 t-1000=100 or greater wear resistance, a Hardness of at least about 65 Shore D, a Static Friction of about 0.208 or lower friction, a Dynamic Friction of about 0.195 or lower friction, a Thermal Expansion of about 0.00018 Degrees C., a Melt Point of about 137-143 Degrees C., a Compressive Modulus of at least about 290 Mpa, a Compressive Deformation of at least about 454%, a Volume Resistivity of greater than about 10¹⁵ Ohm-cm, a Surface Resistivity of greater than about 10¹⁵ Ohm, and a negligible Water Absorption.

7. The pad of claim 3 and:
said washer being formed with a central portion for contacting and welding to said upright member;
said central portion merging into a raised flanged portion adapted to capture said pad flange against said upright member.

8. The pad of claim 1 and:
said pad being one of a set of pads adapted for mounting on a car;
said washer being one of a set of washers adapted for mounting said pads to a car;
said upright member being one of a plurality of upright members spaced longitudinally on a car;
said set of pads being adapted to be mounted such that a pair of said pads is mounted one vertically disposed over the other in respective first vertical positions and second vertical positions on each of said plurality of upright members.

9. The pad of claim 1 and:
said pad being one of a set of pads adapted for mounting on a car;
said washer being one of a set of washers adapted for mounting said pads to a car;
said upright member being one of a plurality of upright members spaced longitudinally on a car;
said set of pads being adapted to be mounted such that one of said pads is mounted on a first upright member in a first vertical position and a second of said pads is mounted in a second vertical position on a second upright member, and said set of pads is mounted such that the set is disposed on alternate upright members said first and second vertical positions, respectively, over the length of said car.

10. The washer of claim 4:
said washer is used to hold the pad on a rail car with a loose fit such that the washer guides the pad during its travel of 1″ or more.

11. The pad of claim 2 and:
said aperture being an inverted “V” shape groove with a countersunk lip that allows the pad to move left and right without restrictions to left and right limits of travel, and when the car becomes empty, the lack of a load placed against said pad allows said pad to drop down by gravity to a centered position.

12. A product protection system for a cargo carrying vehicle with a plurality of upright structural members comprising:
a set of pads adapted for mounting on said vehicle, said pads each having a cargo contact surface and a vehicle contact surface;
each of said pads having a mounting aperture defined by flanges extending inwardly relative to the aperture, said aperture extending through the pad from said cargo contact surface to said vehicle contact surface;
a fastener arrangement for each set of pads adapted for mounting said pads to said vehicle;
said fastener arrangement being adapted to mount at least one of said pads on each of said upright members by capturing said flanges between a weldable washer and said upright member.

13. The product protection system of claim 12 further comprising:
said set of pads being adapted to be mounted such that one of said pads is mounted on a first upright member in a first vertical position and a second of said pads is mounted in a second vertical position on a second upright member, and said set of pads is mounted such that the set is disposed on alternate upright members, each upright member having a pad in both of said first and second vertical positions, respectively, over the length of said car.

14. The product protection system of claim 12 further comprising:
said set of pads being adapted to be mounted such that a pair of said pads is mounted one vertically disposed over the other in respective first vertical positions and second vertical positions on each of said plurality of upright members.

15. The product protection system of claim 12 further comprising:
said pads being formed from a self-lubricating plastic material having a combination of low friction and relatively high strength, stiffness and resistance to compression;
said pads being formed for mounting on the face of said upright members of a cargo carrying vehicle in order to reduce or eliminate damage to product or product wrappers.

16. The pad of claim 15:
said aperture being formed in an inverted “V” shape such that movement of said pad is permitted as the moves by flexing, twisting or wracking.

17. The pad of claim 15 and:
said aperture being formed in a generally circular shape such that said flanges retain of said pad in position as located by said weldable washer.

18. The pad of claim 12 and:
said washer being formed with a central portion for contacting and welding to said upright member;
said central portion merging into a raised flanged portion adapted to capture said pad flange against said upright member.

19. The pads of claim 12 and:
said pad being formed so as to have a density of about 927-938 kg/m³, a Yield Point of at least about 17.8-18.4 Mpa, an elongation at yield of about 12-18%, a tensile break of at least about 50 Mpa, an Elongation at Break of at least about 280%, a Tensile Modulus of at least about 524 Mpa, a Flexural Modulus of at least about 440 Mpa, an Izod Impact of at least about 76 kJ/m², a Tenside Impact of at least about 2868 kJ/m², a Sand Wheel Wear of about 110 t-1000=100 or greater wear resistance, a Hardness of at least about 65 Shore D, a Static Friction of about 0.208 or lower friction, a Dynamic Friction of about 0.195 or lower friction, a Thermal Expansion of about 0.00018 Degrees C., a Melt Point of about 137-143 Degrees C., a Compressive Modulus of at least about 290 Mpa, a Compressive Deformation of at least about 454%, a Volume Resistivity of greater than about 10¹⁵ Ohm-cm, a Surface Resistivity of greater than about 10¹⁵ Ohm, and a negligible Water Absorption.

20. The protection system of claim 12 and:
said washer being formed with a central portion for contacting and welding to said upright member;
said central portion merging into a raised flanged portion adapted to capture said pad flange against said upright member;
said pad being one of a set of pads adapted for mounting on a car;
said washer being one of a set of washers adapted for mounting said pads to a car;
said upright member being one of a plurality of upright members spaced longitudinally on a car;
said set of pads being adapted to be mounted such that a pair of said pads is mounted one vertically disposed over the other in respective first vertical positions and second vertical positions on each of said plurality of upright members.

21. A railroad car having a longitudinal centerline, comprising:
a pair of rail car trucks and a center beam assembly carried thereupon;
said center beam assembly having a lower flange assembly, an upper flange assembly and a web assembly extending between said upper and lower flange assemblies;
said web assembly having a plurality of upwardly extending posts, said posts having a lower region and an upper region;
said web assembly has a non-consumable skirt mounted to said upper region of said posts, and skirt presenting a bearing surface facing laterally outward relative to the longitudinal centerline of said railroad car, against which cargo can bear;
wherein said skirt comprises a self-lubricating plastic material having a combination of low friction and relatively high strength, stiffness and resistance to compression;
said skirt being formed for mounting on the face of said post in order to reduce or eliminate damage to product or product wrappers; and
a flanged aperture to receive a weldable washer for retention of said skirt on the post.

22. An improved railcar for carrying and minimizing damage to cargo, carried thereby;
said car including an elongated floor on which said cargo is positioned and said floor having an longitudinal centerline, a center beam assembly extending longitudinally along the center line of the floor and against which cargo can be positioned, end walls extending upwardly from the floor and the center beam extending between the walls and upwardly from the floor, and said center beam assembly including a plurality of posts extending upwardly from the floor each post defining a flange with an edge portion;
a protective cap construction positioned about a plurality of posts and having:
a face for engaging cargo, which is to be positioned adjacent the flange and which face has a pair of spaced side edges;
a grasping section connected to said face along one edge thereof, having a portion spaced from the face and extending parallel to the face and constructed to grasp said edge portion of said flange; and
a securement leg connected to the face along the other edge, extending rearwardly of the face;
at least one securement device for securing the securement leg, and thus the cap to the post.

23. An improved railcar as in claim 22 wherein the securement device includes at least one tapered aperture extending through the securement leg and a tapered weld washer adapted to fit within the aperture and be welded to the post.

24. An improved railcar as in claim 22 wherein the securement device includes at least one slot extending through the securement leg and at least one T-shaped retainer member having a first leg and a second leg formation extending transverse to and across the top of the first leg, one of said legs shaped to fit within the slot and be secured to the post and the other of said legs arranged to engage and retain the securement legs.

25. An improved railcar as in claim 22, wherein the post is shaped as an angle iron having two (2) legs positioned at about right angles relative to each other with one leg defining an edge portion for the grasping section and the other leg defining a web like member for engagement by the securement leg.

26. An improved railcar as in claim 22, wherein the post has the shape of an I-beam and includes a pair of spaced and substantially parallel flanges and web positioned therebetween, and the cap includes as securement device at least one slot extending through the securement leg and at least one T-shaped retainer member, the cargo is positioned engaging face adjacent to the flange, the grasping section engages an edge of the flange and the T-shaped retainer engages the securement leg via the slot and the T-shaped member is a welded to the flange so as to secure the cap on the post.

27. An improved railcar as in claim 22 wherein the post has a Z like shape and defines an upper and lower flange which are substantially parallel to each other but extend in opposite directions and a web therebetween connecting the flanges, and the cap includes as the securement device at least one slot extending through the securement leg and at least one T-shaped retainer member having a cross member portion, the cargo engaging face is positioned adjacent a flange, the grasping section grasps the free edge of the flange and the securement bag extends rearwardly of the face and the retainer member is fitted into the slot and positioned to be welded to the web so as to secure the cap in position on the post.

28. An improved railcar as in claim 22 wherein the post has a channel-like shape which defines an upper and a lower flange which are substantially parallel to each other and extend in the same direction, and a web therebetween connecting the flanges and the cap includes a securement device which includes at least one tapered aperture extending through the securement leg and at least one tapered weld washer adapted to fit within the tapered aperture, wherein the cargo engaging faces is positioned adjacent to a flange, the grasping section grasps the free edge of the flange and the securement leg extends rearwardly of the face and is positioned adjacent the web and the weld washer is welded to the web so as to secure the cap on the position on the post.
